(19) United States
(12) Patent Application Publication
(10) Pub. No.: US 2014/0006263 A1
(43) Pub. Date: Jan. 2, 2014

(54) System, Software, and Method For Design And Personalization Of Content By Users

(71) Applicant: Daniel Ray Townsend, Lutherville, MD (US)

(72) Inventor: Daniel Ray Townsend, Lutherville, MD (US)

(21) Appl. No.: 13/755,031

(22) Filed: Jan. 31, 2013

Related U.S. Application Data
(60) Provisional application No. 61/665,561, filed on Jun. 28, 2012.

(51) Int. Cl. G06F 3/0481

(52) U.S. Cl. CPC G06F 3/04817
USPC 705/39; 715/765

(57) ABSTRACT

A method for personalization of content by a user comprises providing artwork, providing a template, combining the artwork and template to produce a personalized icon, and linking and displaying a plurality of personalized icons to create a continuous group for displaying preferences of the user.

### REFERENCE TO RELATED APPLICATION

This application claims the benefit of U.S. Provisional Patent Application No. 61665561, filed Jun. 28, 2012, entitled “A DIGITAL COMPUTERIZED SYSTEM FOR DESIGNING LIFE ICONS.”

### BACKGROUND OF THE INVENTION

The present invention relates to a system for design and personalization of content by users. Currently, users have no choice of content other than standardized symbols and graphics limiting the users' ability for personal content.

As can be seen, there is a need for solutions to these and other problems.

### SUMMARY OF THE INVENTION

In one aspect of the present invention, a method for personalization of content by a user comprises: providing artwork; providing a template; combining the artwork and template to produce a personalized icon; and displaying the personalized icon.

In one aspect, the method further comprises modifying at least one of a shape, a size, a border, a text, a font, and a color of the template. In one aspect, the method further comprises originally creating the artwork. In one aspect, the method further comprises paying a royalty to a user for originally creating the artwork. In one aspect, the method further comprises paying a royalty to a user for producing the personalized icon. In one aspect, the method further comprises linking and displaying a plurality of personalized icons to create a continuous group for displaying preferences of a user. In one aspect, the method further comprises standardizing the plurality of personalized icons according to at least one of a shape, a size, a border, a text, a font, and a color. In one aspect, the method further comprises electronically displaying the plurality of personalized icons on a screen. In one aspect, the method further comprises displaying the plurality of personalized icons on at least one of a textile and a ceramic product.

In one aspect, the method further comprises: providing the template on a server; downloading the template to a client processor; and uploading the personalized icon from the client processor to the server. In one aspect, the method further comprises linking the personalized icon to a software application.

In one aspect, a system for personalization of content by a user comprises: a machine; and a program product comprising machine-readable program code for causing, when executed, the machine to perform the following process steps: providing artwork; providing a template; prompting a user to combine the artwork and template to produce a personalized icon; and displaying the personalized icon.

These and other features, aspects and advantages of the present invention will become better understood with reference to the following drawings, description and claims.

### BRIEF DESCRIPTION OF THE DRAWINGS

FIG. 1: is a schematic view of one embodiment of the invention overall process.

FIG. 2: is a schematic view of one embodiment of the invention icon creation process.

FIG. 3: is an exemplary schematic view of the icons shown in combination.

FIG. 4: is a schematic view of the icons shown in exemplary computer icon application.

FIG. 5: is a front view of the icons shown in textile application.

FIG. 6: is a perspective view of one embodiment of the invention shown in exemplary glassware/ceramic application.

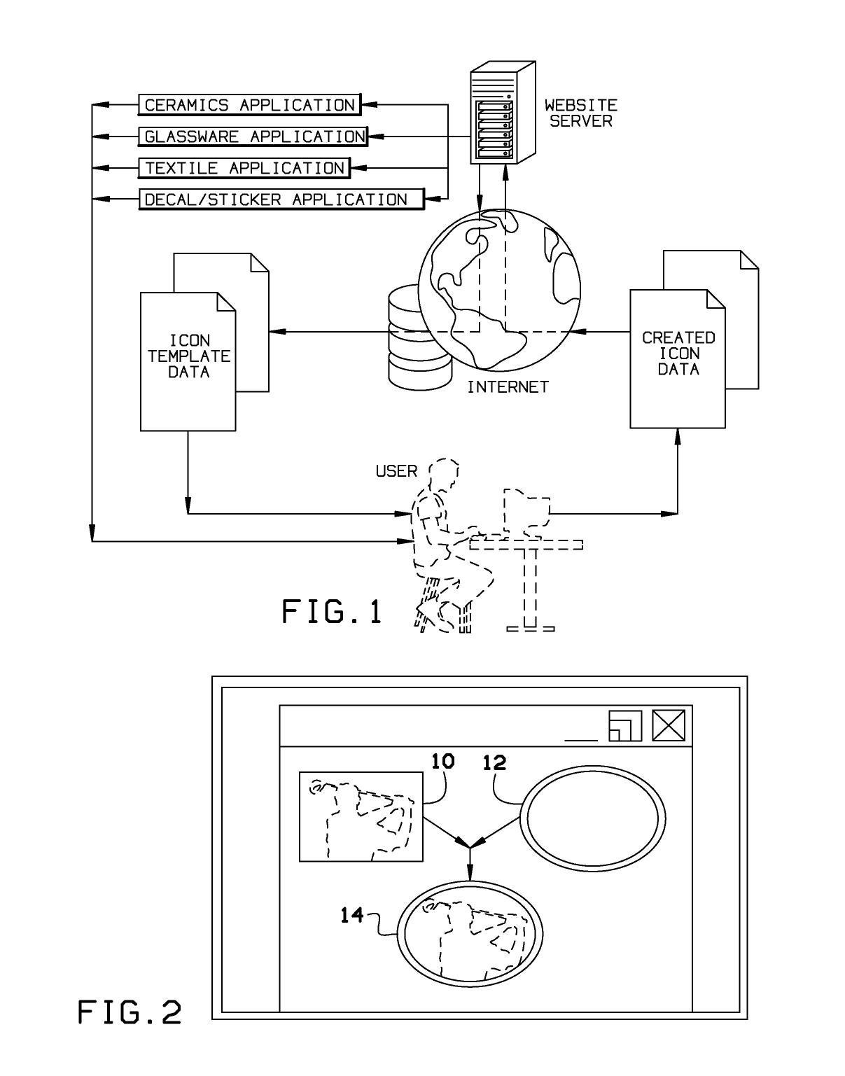

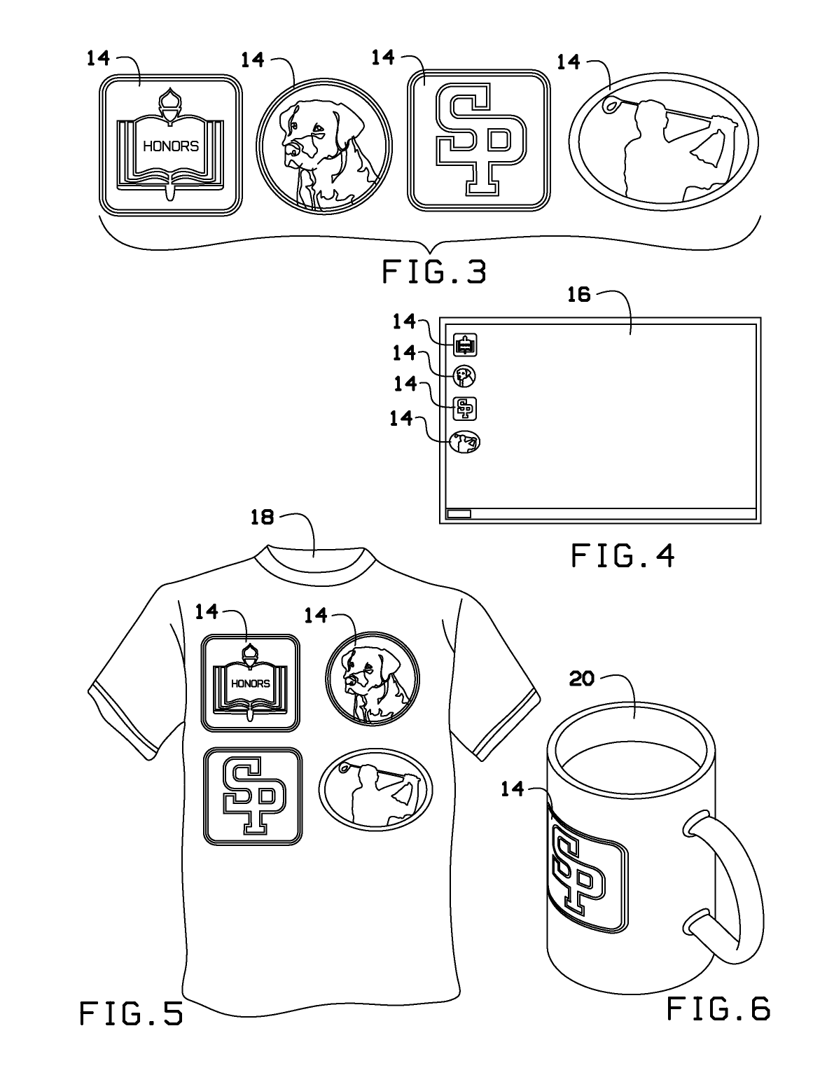

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Referring now to the figures, the following reference numbers may refer to elements of the invention:
10: is the artwork exemplification.
12: is the icon template exemplification.
14: is the personalized icon exemplification.
16: is the screen exemplification.
18: is the textile exemplification.
20: is the glassware/ceramic exemplification.

The present invention allows for an ability to communicate through visual icons an individual's personnel life story in one continuous linked visual. It allows the user control over their content without being shoehorned into standardized graphics. It allows the user to show their personal preferences as well as allows them to create their personal choices. It allows them the ability to assemble a pool of icons depicting schools, sports, hobbies, destinations, professional life, music, etc., into a personnel profile depicting an individual's life structure, life and personality.

This invention is an improvement on what currently exists. Through a series of designed templates, the user can design their own content or icons generating visuals that are unique to them. Original artworks by a user can be reused by another user and receive royalties for its usage. Also, the invention can produce icons to be printed on textiles, paper and plastic substrates and ceramics.

A Version of the Invention Discussed Here Includes:
1. Website
2. Templates and Icons
3. Assembly of content
4. Order content

The user has control over their chosen and created elements following a template format according to the present invention. The templates have been designed to work in any configuration. All original artworks may work within the template perimeters.

Users may create artwork and content on a website. The templates can be downloaded to their computers to design to the frames and upload to the website for inclusion. The end user has the control over content.

Users may build what they want to output in real time on a dedicated website. They could use original artworks available on the website, they could use another author's original artworks (and possibly pay a royalty to the creator), or they may create their own unique original artworks which could add to the pool of icons for use by another user. Further, chosen icons can be assembled as working icons for a computer interface.

Broadly, an embodiment of the present invention provides a method for allowing a user to create original works on digitally supplied design templates through a dedicated website. The website also makes these templates downloadable for the user to design on personal computers and upload to a secure website.

The user of the new method has the ability to design/create personal, visual imagery or “original works of art” by using a method of pre-designed templates and assemble original works into a personalized structure. By fostering control of the visual creation process to a user, this new visual imagery will allow the user to express their own personal individuality through their own works.

The method involves a user's ability to create what they want, which may or may not be recognizable or known by anyone other than the individuals creating it. The method gives complete control to the individuals to design their own particular life events, likes/dislikes, without being limited to the use of standardized symbols and commonly recognizable available elements.

The method includes a website which will provide detailed instructions, templates and suggestions for the user to follow while creating imagery. The imagery may be created by the user on a personal computer and uploaded to the system website, allowing them to place their work in a structured visual representation of their choice.

With original works or visual content created by the user, icons can reflect unique elements and images that are not available. The user controls the design software and creates original works. As a result, users are not beholden to standardized symbols and universally accepted images known by the general public. The process of designing individualized icons makes structured identification more personal.

The icons can either work together visually depicting a storyline, or be shown in random order with no visual relationship to each other. The icons however, may follow a set template configuration (such as all having similar borders, sizes, shapes, designs, etc.). The visual scope of the users' creation is controlled by the creator/creators of the original works.

User-created icons or original visual content can be visually linked by the user allowing the images to work together to show a user's personal life structure depending on what they design or use. However, created visuals may tell no story, with designs done by the creator in which the creator can only interpret.

The user has the ability to use a secure website where design templates, instructional information, and design software are located. The user may design the template using tools provided by the website or upload a template designed on their own computer. Finished templates are saved and uploaded to the secure website where a user can finalize the design and ordering process.

The website will have control features and directions as to assemble chosen icons in a simplistic format. The individual will build their grouping in real time so they can see the chosen icons working together visually allowing them choices in color and variation.

The invention enables the original visual content to be printed on textiles including but not limited to T-shirts and embroidery. The original content can also be printed on decals/stickers, clothing, ceramics; including mugs, bowls, plate-ware and glass.

Original visual content can also be downloaded through created software to personal computers and can be activated as working digital programmed icons for personal use.

Original visual content created by the user will be owned by the originator as intellectual property and may be supported by royalty fees as in the usage rights of any original work. The user is afforded complete control over the content they would like. Additional content will be available using other created original art in our files where the originator of the art will receive a royalty for usage.

In one aspect, the user creates (and possibly uploads) a brand new graphic or artwork, such as by drawing and scanning the work, using software to draw new artwork, creating the work through photography, digital editing, and so forth. Any means of creating visual art is within the scope of the present invention. This artwork 10 is then uploaded to a server of the website, according to the present invention.

This artwork 10 may be combined with an icon template 12, which may have a preset or changeable border, shape, size, color, design, text/writing, etc. Alternatively or in addition, the user may be able to change one or more features or attributes of the icon template 12, such as changing the color, size, text, etc. The user may then combine the artwork 10 with the icon template 12 to create a personalized icon 14.

The creation of the original artwork may comprise the creation of artwork 10 and/or the creation of personalized icon 14 by combining existing artwork 10 with icon template 12.

In one aspect, original works created by users may be stored on the server and made available to other users for purchase or use, either for free or by paying a royalty. The royalty prices may vary depending on whether the artwork 10 itself is original or whether the original work consists of existing artwork 10 combined in an original fashion with icon template 12 (which may, itself, be modified creatively and originally by a user) to produce personalized icon 14. The price may be higher for original artwork 10 versus original icons 14, or may depend on the demands of the creator.

In one aspect, a series of icons 14 are linked together and displayed (such as by displaying on a screen (FIG. 4), printed and displayed on a textile (FIG. 5), or printed and displayed on another product, such as a ceramic mug (FIG. 6)) to create a story or description of a person's lifestyle or preferences, or to create a continuous group or graphics chain. In one aspect, the icons 14 are standardized (or made uniform) in at least one of size, shape, border, color, text, and font. For instance, if a person was a graduate of a university whose colors were orange and blue, the user could select an icon template 12 that has these colors, and/or modify an existing icon template 12 to include these colors, and then combine various artworks 10 with this single template 12 to produce a variety of icons 14 that represent her preferences and/or lifestyle while maintaining a standardization (in this case, the colors orange and blue). Alternatively or in addition, a font may be standardized throughout the linked icons 14, or the shape of the icons 14, etc.

In one aspect, the method includes creating original artworks 10 so as to create a pool of choices an individual can pull from if they so choose. For example an experienced graphic artist may create a series of original dog images covering every breed, which would be made available for use and, if purchased by other users, the creator of the art may get a royalty for usage rights. If the artwork 10 contains just a shell or outline of the dog a user would be able to add color or defining spots or characteristics to the form as well as names if they so choose. These changes can be made on the template on the present website, or downloaded templates can be worked on at a home computer and uploaded to the present website.

Further, computer programs readily available that will allow an individual to manipulate original photos to a graphic state are within the scope of the present invention. Templates 12 include a preset set of templates to maintain size and visual unity.

The present invention includes encouraging artists and assembling groups of artists to create original artwork 10 that can be sold, licensed, or used by other users in creating personalized icons 14 and/or series of icons 14 to be displayed.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A method for personalization of content by a user, comprising:
providing artwork;
providing a template;
combining the artwork and template to produce a personalized icon; and
linking and displaying a plurality of personalized icons to create a continuous group for displaying preferences of the user.

2. The method as claimed in claim 1, further comprising modifying at least one of a shape, a size, a border, a text, a font, and a color of the template.

3. The method as claimed in claim 1, further comprising originally creating the artwork.

4. The method as claimed in claim 3, further comprising paying a royalty to a user for originally creating the artwork.

5. The method as claimed in claim 1, further comprising paying a royalty to a user for producing the personalized icon.

6. The method as claimed in claim 1, further comprising standardizing the plurality of personalized icons according to at least one of a shape, a size, a border, a text, a font, and a color.

7. The method as claimed in claim 1, further comprising electronically displaying the plurality of personalized icons on a screen.

8. The method as claimed in claim 1, further comprising displaying the plurality of personalized icons on at least one of a textile and a ceramic product.

9. The method as claimed in claim 1, further comprising:
providing the template on a server;
downloading the template to a client processor; and
uploading the personalized icon from the client processor to the server.

10. The method as claimed in claim 1, further comprising linking the personalized icon to a software application.

11. A system for personalization of content by a user, comprising:
a machine; and
a program product comprising machine-readable program code for causing, when executed, the machine to perform the following process steps:
providing artwork;
providing a template;
prompting a user to combine the artwork and template to produce a personalized icon; and
linking and displaying a plurality of personalized icons to create a continuous group for displaying preferences of the user.
